(19) United States
(12) Patent Application Publication
(10) Pub. No.: US 2021/0291203 A1
(43) Pub. Date: Sep. 23, 2021

(54) DIGITAL MIST NOZZLE STRUCTURE

(71) Applicant: FILTERTECH Co., Ltd., Daejeon (KR)

(72) Inventors: Jae Ui HONG, Daejeon (KR); Seo Yun PARK, Daejeon (KR)

(21) Appl. No.: 17/111,694

(22) Filed: Dec. 4, 2020

(30) Foreign Application Priority Data
Mar. 17, 2020 (KR) 10-2020-0032511

(51) Int. Cl. B05B 1/04; B05B 17/06

(52) U.S. Cl. CPC B05B 1/044; F24F 3/14; B05B 17/0653

(57) ABSTRACT

The present invention relates to a digital mist nozzle structure that is connected to a general pipeline and continuously sprays water or a chemical solution in the form of a mist, so that it can be efficiently used for indoor humidification or entrance disease prevention. In order to accomplish the above object, the present invention provides a digital mist nozzle structure including: a pipe connector formed in a T shape and configured to be connected to a pipeline; a nozzle body connected to the pipe connector; an ultrasonic vibration nozzle coupled to one end of the nozzle body; and a nozzle cap fastened to the nozzle body in order to prevent the ultrasonic vibration nozzle from being separated.

### CROSS-REFERENCE TO RELATED APPLICATION

This application claims the benefit of Korean Patent Application No. 10-2020-0032511 filed on Mar. 17, 2020, which is hereby incorporated by reference herein in its entirety.

### TECHNICAL FIELD

The present invention relates generally to a mist nozzle structure, and more particularly to a digital mist nozzle structure that can be connected directly to a pipeline and can also spray water or a chemical solution in the form of fine mist particles, thereby being utilized for indoor humidification and disease prevention.

### BACKGROUND

In general, spraying devices that spray a liquid such as water through a plurality of nozzles are widely used for the purpose of cultivating crops for the growth of plants, for the purpose of lowering the temperature of livestock houses such as poultry farms or pig houses, for the purpose of lowering the temperature of heat islands such as the outer walls of buildings or roads in summer, etc.

In other words, spraying devices for spraying a liquid such as water or a chemical solution onto crops for the growth of plants are installed and used in crop houses where various crops are grown. An example of the prior art regarding these spraying devices for the growth of plants is described in Korean Patent Application Publication No. 10-2011-0069357, which is a prior art patent document.

In addition, spraying devices for spraying water onto an outer wall in the form of a mist are installed and used on the outer walls of buildings in order to prevent temperature from rising and lower temperature when the temperature rises high, as in summer. An example of the prior art regarding these spray devices for lowering the temperature of the outer wall of a building is described in Korean Utility Model Registration No. 20-0434106, which is a prior art patent document.

Such a spraying device used for the above-described purpose includes a hose configured to supply water, a plurality of T-type branch pipes connected to the hose, and a plurality of nozzles connected to the respective branch pipes in order to spray water in the form of a mist.

However, conventionally, in order to spray water through a nozzle, water to be supplied must be supplied at a specific pressure or higher. Accordingly, in an area where water pressure is low, a problem arises in that the use of the spraying device is limited by an installation environment because a separate high-pressure pump must be additionally connected and installed.

Meanwhile, as the prior art for mitigating the above problem, Korean Patent Application Publication No. 2019-133452 (published on Dec. 3, 2019) discloses a technology regarding a nozzle structure that improves the structure of a spray nozzle so that water is efficiently sprayed in the form of a mist even when water is supplied at low pressure.

However, in the above-described prior art, a mechanical nozzle spraying structure is formed by components including a filter membrane, a check valve, and an elastic spring, and thus problems arise in that breakdowns occur frequently and there is a limitation in the atomization of spraying.

### SUMMARY

The present invention has been proposed to mitigate the above-described problems of the prior art, and an object of the present invention is to provide a digital mist nozzle structure that performs a more effective nozzle spraying operation by enabling digital mist spraying using ultrasonic vibrator parts and enables continuous spraying by being connected directly to a pipeline.

In order to accomplish the above object, the present invention provides a digital mist nozzle structure including: a pipe connector formed in a T shape and configured to be connected to a pipeline; a nozzle body connected to the pipe connector; an ultrasonic vibration nozzle coupled to one end of the nozzle body; and a nozzle cap fastened to the nozzle body in order to prevent the ultrasonic vibration nozzle from being separated.

The ultrasonic vibration nozzle includes: a metal diaphragm configured such that 8 micro-laser-punched pores are formed therein; and a silicone cover configured such that an upper through hole and a lower through hole are formed therein in order to protect the metal diaphragm. The upper through hole is formed to be larger than the lower through hole.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is an exploded perspective view of a digital mist nozzle structure according to an embodiment of the present invention;

FIG. 2 is an exploded perspective view of an ultrasonic vibration nozzle according to the present invention;

FIG. 3 is a sectional view taken along line A-A of FIG. 2;

FIG. 4 is a sectional view showing the structure of the ultrasonic vibration nozzle according to the present invention;

FIG. 5 is an assembled perspective view of the digital mist nozzle structure according to the present invention;

FIG. 6 is an exploded sectional view of the digital mist nozzle structure according to the present invention;

FIG. 7 is an assembled sectional view of the digital mist nozzle structure according to the present invention;

FIG. 8 is an assembled bottom perspective view of the digital mist nozzle structure according to the present invention;

FIG. 9 is a side view showing the structure of the installed digital mist nozzle structure according to the present invention;

FIG. 10 is an enlarged sectional view of a silicone cover according to another embodiment of the present invention; and

FIG. 11 is a plan view of a pressure regulator according to the other embodiment of the present invention.

### DETAILED DESCRIPTION

Specific embodiments of the present invention will be described in detail below with reference to the accompanying drawings.

The embodiments of the present invention may be modified in various forms, and the scope of the present invention should not be construed as being limited to the embodiments described in detail below. These embodiments are provided to more completely describe the present invention to those having ordinary knowledge in the art.

Accordingly, the shapes of components in the drawings may be exaggerated to offer more clear illustrations.

It should be noted that the same components may be denoted by the same reference numerals throughout the accompanying drawings. Furthermore, detailed descriptions of functions and configurations of known technologies that are determined to unnecessarily obscure the gist of the present invention may be omitted.

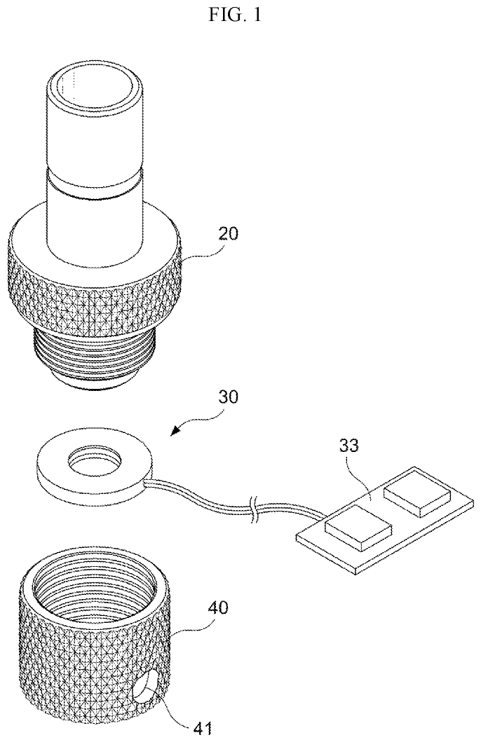

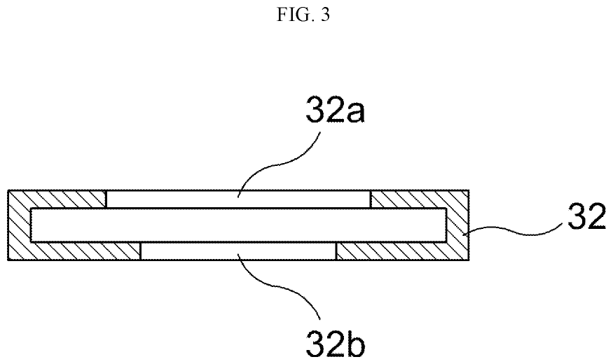

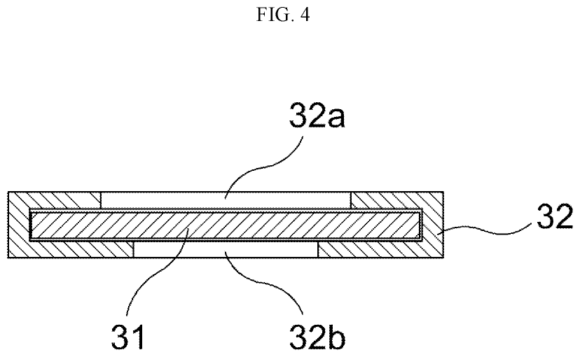

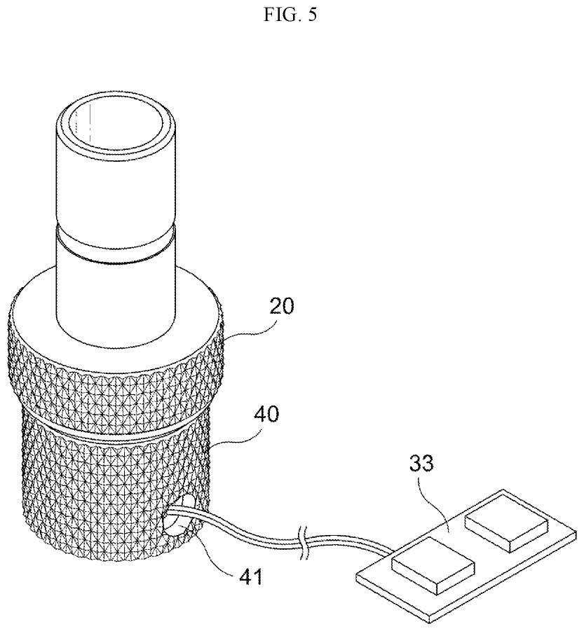

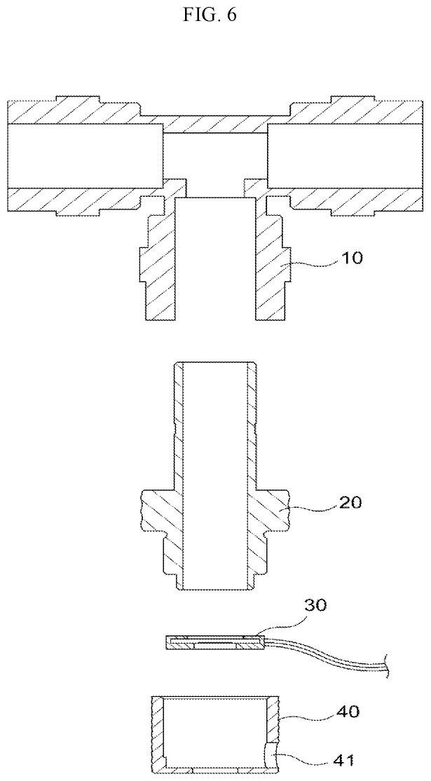

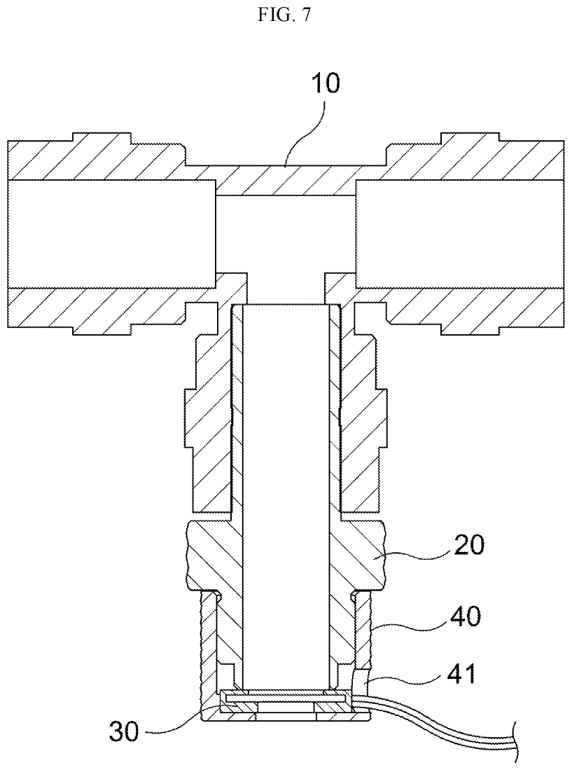

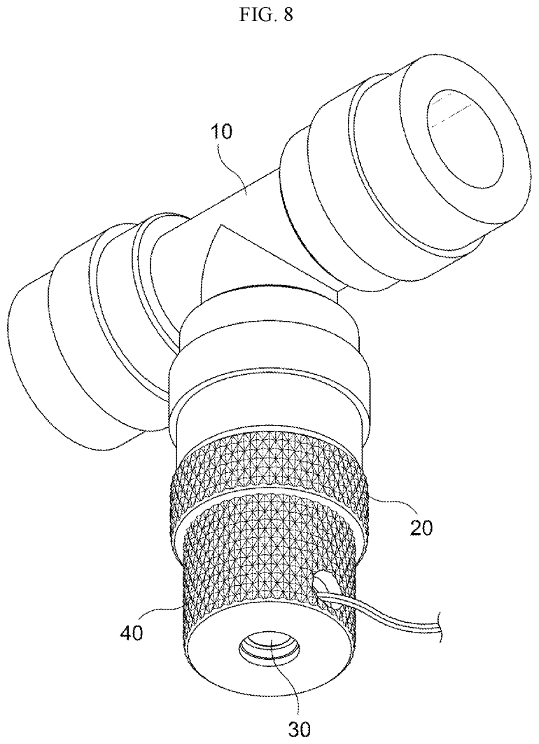

First, the configuration of a digital mist nozzle structure according to an embodiment of the present invention will be described with reference to FIGS. 1 to 8.

The digital mist nozzle structure according to the present embodiment includes: a pipe connector 10 formed in a T shape and configured to be connected to a pipeline 100; a nozzle body 20 connected to the pipe connector 10 in a one-touch manner; an ultrasonic vibration nozzle 30 coupled to one end of the nozzle body 20; and a nozzle cap 40 screwed to the nozzle body 20 in order to prevent the ultrasonic vibration nozzle 30 from being separated.

In particular, a wire guide hole 41 configured to guide an electric wire connected to the ultrasonic vibration nozzle 30 is formed in the nozzle cap 40.

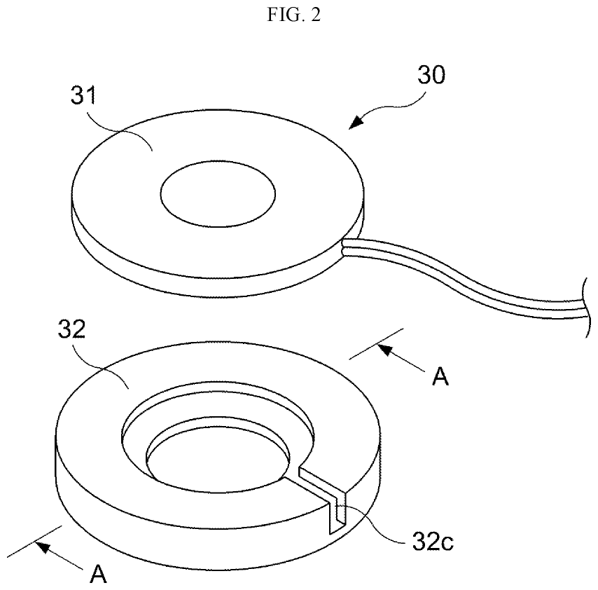

Furthermore, it can be seen from FIGS. 2 to 4 that the ultrasonic vibration nozzle 30 includes a piezo-metal diaphragm 31 fabricated by forming 8 micro-laser-punched pores in an aluminum or stainless steel plate having a thickness of 0.8 mm and a silicone cover 32 provided with an upper through hole 32a and a lower through hole 32b in order to protect the metal diaphragm 31.

In the silicone cover 32, the upper through hole 32a is preferably formed to be larger than the lower through hole 32b, and a wire guide depression 32c configured to guide an electric wire is formed on one side of the silicone cover 32.

In the drawings, reference numeral 33 denotes a PCB substrate connected to control the operation of the ultrasonic vibration nozzle 30.

The effect of the operation of the digital mist nozzle structure of the present invention configured as described above will now be described.

The digital mist nozzle structure according to the present invention is installed and used for indoor humidification or low-pressure disease prevention for spraying a chemical solution.

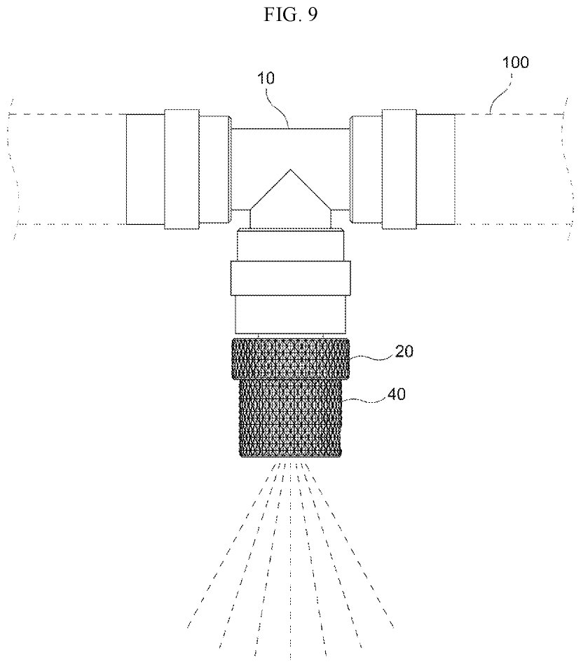

In other words, as shown in FIG. 9, the digital mist nozzle structure is installed indoors or at the entrance door of a corridor by connecting the pipe connector 10 to the pipeline 100. When a fluid such as water or a chemical solution supplied through the piping line 100 flows into the nozzle body 20, fine particles are formed by the operation of the ultrasonic vibration nozzle 30 and thus the fluid is continuously sprayed in the form of a mist.

In particular, the mist nozzle structure according to the present invention allows water to be sprayed at a low pressure using ultrasonic waves, so that a uniform humidification effect can be achieved throughout an indoor space.

Furthermore, the mist nozzle structure according to the present invention may be installed and removed at various locations as necessary because the nozzle body 20 has a connection structure that can be attached and detached using the pipe connector 10 in a one-touch manner.

In addition, since the ultrasonic vibration nozzle 30 of the present invention has a detachable structure in which the metal vibration plate 31 is protected by the silicon cover 32, it may be easily replaced and mounted as needed in case of a breakdown.

Accordingly, the mist nozzle structure according to the present invention is connected to a general pipeline and continuously sprays water or a chemical solution in the form of a mist, thereby providing the effect of being effectively utilized for indoor humidification or door disease prevention.

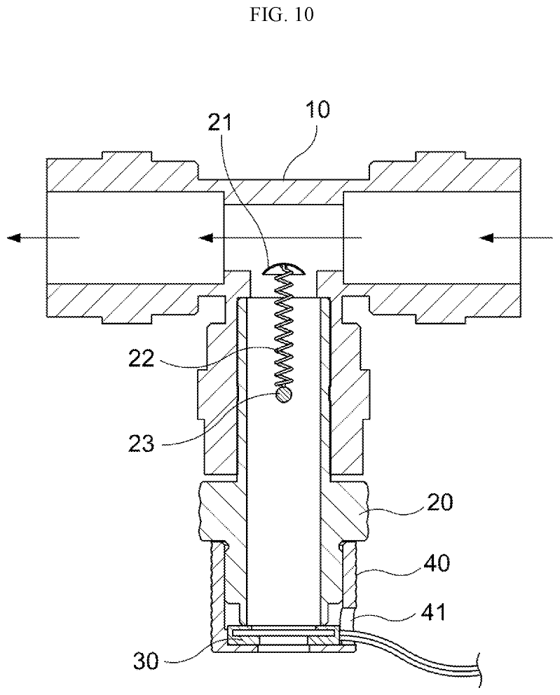

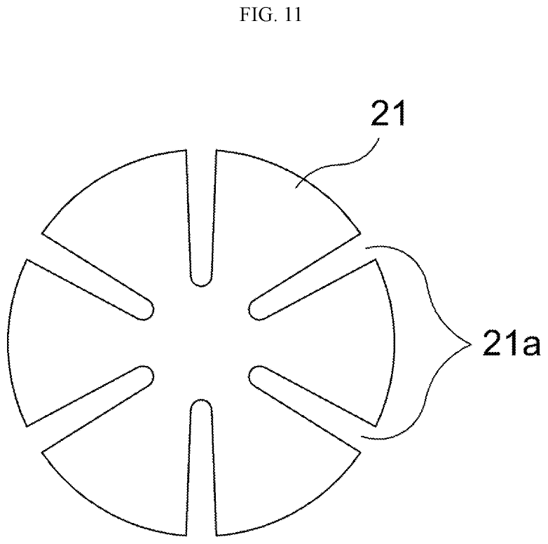

Meanwhile, FIGS. 10 and 11 show the configuration of a digital mist nozzle structure according to another embodiment of the present invention. A pressure regulator 21 configured to form a specific curved shape such as a hemispherical shape to control the pressure of a fluid in a pipe is disposed at the same height as the flow of the fluid in the pipe inside the nozzle body 20, the pressure regulator 21 is elastically supported by an elastic spring 22, and a spring support 23 configured to support the elastic spring 22 is disposed on the center portion of the inside of the nozzle body 20.

Furthermore, it can be seen that the pressure regulator 21 has a plurality of slits 21a formed along the circumference thereof at regular intervals in radial directions so that the aperture thereof can be varied and changed by internal fluid pressure.

Due to the above-described configuration, the rapid inflow of the fluid flowing through the pipe to the nozzle side is limited by the curved pressure regulator 21 and the stable guidance of the fluid may be achieved.

Accordingly, the high-pressure fluid in the pipe is prevented from flowing into the nozzle body 20 instantaneously, thereby preventing the breakdown of the ultrasonic vibration nozzle 30 from occurring and also allowing a mist to be stably sprayed.

In particular, it can be seen that the pressure regulator 21 is elastically supported by the elastic spring 22 so that cushioning control is performed.

Furthermore, since the plurality of slits 21a is formed in the pressure regulator 21 in the radial directions so that an inflow space can be varied by fluid pressure, thereby achieving the advantage of maintaining appropriate fluid pressure.

Although the specific embodiments of the present invention have been described and illustrated above, it is obvious that the device structure of the present invention may be modified and implemented in various manners by those skilled in the art.

For example, although the pipe connector has been described and illustrated as having a T shape in the above embodiment, the shape of the pipe connector may be modified as necessary.

In addition, various materials such as metal or synthetic resin may be used as the material of each component.

The digital mist nozzle structure according to the present invention is connected to a general pipeline and continuously sprays water or a chemical solution in the form of a mist, so that it can be efficiently used for indoor humidification or entrance disease prevention.

Although the specific embodiments of the present invention have been disclosed for illustrative purposes, those skilled in the art will appreciate that various modifications, additions and substitutions may be possible without departing from the scope and spirit of the invention as disclosed in the accompanying claims.

What is claimed is:

1. A digital mist nozzle structure comprising:
a pipe connector configured to be connected to a pipeline;
a nozzle body connected to the pipe connector;
an ultrasonic vibration nozzle coupled to one end of the nozzle body; and
a nozzle cap fastened to the nozzle body in order to prevent the ultrasonic vibration nozzle from being separated;
wherein a pressure regulator configured to form a specific curved shape to control a pressure of a fluid in a pipe is disposed at a same height as a flow of the fluid in the pipe inside the nozzle body, the pressure regulator is elastically supported by an elastic spring, and a spring support configured to support the elastic spring is disposed on a center portion of an inside of the nozzle body.

2. The digital mist nozzle structure of claim 1, wherein a wire guide hole configured to guide an electric wire connected to the ultrasonic vibration nozzle is formed in the nozzle cap.

3. The digital mist nozzle structure of claim 1, wherein the ultrasonic vibration nozzle comprises:
a metal diaphragm configured such that 8 micro-laser-punched pores are formed therein; and
a silicone cover configured such that an upper through hole and a lower through hole are formed therein in order to protect the metal diaphragm;
wherein the upper through hole is formed to be larger than the lower through hole, and a wire guide depression configured to guide an electric wire is formed on one side of the silicone cover.

4. The digital mist nozzle structure of claim 1, wherein the pressure regulator has a plurality of slits formed along a circumference of a disk shape of the pressure regulator at regular intervals in radial directions.
